(19) United States
(12) Patent Application Publication
(10) Pub. No.: US 2004/0159334 A1
(43) Pub. Date: Aug. 19, 2004

(54) Cleaning tool for mechanical parts

(76) Inventor: Daniel H. Katsin, Mill Valley, CA (US)

Correspondence Address: Samuel S. Lee, DERGOSITS & NOAH LLP, Suite 1450, Four Embarcadero Center, San Francisco, CA, 94111, US

(21) Appl. No.: 10/370,881

(22) Filed: Feb. 19, 2003

(51) Int. Cl. A47L 25/00; B08B 9/04

(52) U.S. Cl. 134/8; 15/104.001; 15/210.1

(57) ABSTRACT

The present invention is directed to an apparatus and method using the apparatus for cleaning a mechanical component with a void space. The apparatus includes a planar backing layer made of a resilient material and a woven layer attached to the backing layer to form a laminate, wherein the laminate is substantially flat and shaped to have an elongated body portion and at least one tapered end portion.

### FIELD OF INVENTION

The present invention relates to an apparatus for cleaning mechanical parts. In particular, the present invention relates to an apparatus for cleaning mechanical parts having difficult to reach surface areas.

### BACKGROUND OF THE INVENTION

Over the last three decades recreational and transportation devices, such as bicycles and motorcycles, have grown more complex with increasing mechanical precision. As a result, their functionality, reliability and safe operation have become more dependent on consistent performance of all of the interrelated parts at optimum specified levels. This has increased the need for each component to be kept free of the debris, which typically accumulates as a result of normal and extreme use. In the past, household rags and various kinds of brushes were sufficient to clean the gears of many bicycles and motorcycles. However, increasing engineering precision and complexity of components has created a need for special tools for proper cleaning. The present invention provides an apparatus and method of using the apparatus to meet this need.

### SUMMARY OF THE INVENTION

The present invention is directed to an apparatus for cleaning a mechanical component with a void space. The apparatus includes a planar backing layer made of a resilient material and a woven layer attached to the backing layer to form a laminate, wherein the laminate is substantially flat and shaped to have an elongated body portion and at least one tapered end portion. The body portion can be formed into any suitable geometric shape, such as, for example, a polygon, an ellipse, or a circle. The tapered end portion can also be formed into any suitable shape, such as, for example, a hook or polygon. In one embodiment, the elongated body portion has a substantially rectangular shape having a length and a height and the tapered end portion has a substantially triangular shape. In another embodiment, the woven layer is made of a synthetic microfiber.

The present invention is also directed to a method of cleaning a mechanical component with a void space. The method includes placing a cleaning apparatus, according to the present invention, in the void space of a mechanical component, and contacting the woven layer with a surface of the mechanical component. In one embodiment, the method can further include the step of applying a cleaning solution to the woven layer of the cleaning apparatus before the placing the cleaning apparatus in the void space of the mechanical component.

### BRIEF DESCRIPTION OF THE DRAWINGS

While the specification concludes with claims particularly pointing out and distinctly claiming the subject matter, which is regarded as defining the present invention, it is believed that the invention will be better understood from the following description taken in conjunction with the following accompanying drawings:

FIG. 1A is an illustration of one embodiment of the present invention, and FIG. 1B is a cross section view along axis X-X of the embodiment illustrated in FIG. 1A;

FIG. 2 is an illustration of another embodiment of the present invention; and

FIG. 3 is an illustration of another embodiment of the present invention.

### DETAILED DESCRIPTION OF THE INVENTION

The present invention provides a apparatus to remove foreign matter, e.g., dirt, dust, accumulated lubricant, moisture and the like, from the areas in and around a mechanical component having a void space, e.g., the rear cogs or gear cassette and the chain ring of a bicycle. The shape and geometry of the invention are selected so that the apparatus can be slid into the void spaces of the mechanical components. A mechanical component having a void space, as used herein, means any mechanical part that has surface areas forming one or more interior spaces through which the apparatus of the present invention can be passed to clean the surface areas. Examples of such mechanical components include, but are not limited to, bicycle parts, such as rear cogs, gear cassettes, and chain rings.

The present invention provides an apparatus and a method of using the apparatus for cleaning a mechanical component with a void space. The apparatus includes a planar backing layer made of a resilient material attached to woven layer to form a substantially flat laminate.

The planar backing layer provides support for the woven layer. Preferably, the backing layer is made of a material that also allows the apparatus to easily slide into the void space without damaging the surface areas. The backing layer can be made of any resilient material known in the art. Examples of suitable materials include, but are not limited to, plastics, such as acrylonitryl butadiene styrene (ABS), polystyrene, polyethylene, polypropylene, and the like.

The woven layer provides a cleaning surface for removing foreign matter in the void space of the mechanical component. The woven layer can be chosen to provide one or more functionalities, such as absorbency, scrubbing ability, and resilience. Preferably, the woven layer is made of a synthetic fiber having a denier of from about 0.01 to about 50. The woven layer is more preferably made of a microfiber having a denier of from about 0.01 to about 0.99. The woven layer can be made of a split microfiber, unsplit microfiber, or a combination thereof. The loop size can be selected to be small enough to prevent tangling in the features of the mechanical component being cleaned. Examples of suitable materials include, but-are not limited to, wovens made from natural fibers, such as cotton, silk, linen, and combinations thereof, and wovens made from synthetic fibers, such as polyester, polyamide (nylon), rayon, acrylic, and combinations thereof. Nonlimiting examples of useful materials include: microfibers, such as MFT 1, 2, 3, 5, 11.3, and 35, which are commercially available from Leading Edge Products located in San Diego, Calif.; microfibers made with polyester and polyamide in a weight percentage ratio ranging from about 50/50 to about 90/10; microfibers made from 100% polyester; and microfibers made from 100% polyamide (nylon). Wovens can be obtained from any combination of the fibers described above, wherein the fibers have a weight from about 35 grams to about 850 grams/m².

The apparatus of the present invention can be formed by attaching the backing layer with the woven layer to form a substantially flat laminate. The laminate can be formed by any method known in the art. For example, a suitable adhesive can be used to form the laminate or the backing layer can be heat formed onto the woven layer. The laminate is preferably formed to provide significant resistance to solvents are typically used in cleaning the mechanical component.

Once formed, the laminate can be shaped to have an elongated body portion and at least one tapered end portion. The body portion can be used as a handle. Preferably, the dimensions of the body portion (e.g., height and width) can be tailored to the dimensions of the void space of the mechanical component to be cleaned. Therefore, the body portion can be formed into any suitable geometric shape, such as, for example, a polygon, an ellipse, or a circle. For example, the height of the body portion can be matched to the height or radius of the largest gear in the gear cassette of a bicycle. Similarly, the width of the laminate can be matched (e.g., by choosing the proper thicknesses of the backing and/or woven layer) to be equal to or less than the spaces in between the gears of a gear cassette. The tapered end portion allows increased functionality for use as a pick to reach deep into the void spaces, e.g., crevices, of a mechanical component. The tapered end portion can also be formed into any suitable shape, such as, for example, a hook or polygon. Accordingly, the present invention can have more than one tapered end portion. For example, the elongated body portion can have two tapered end portions extended from the body portion, e.g., extending from opposite sides of the body portion.

The elongated body portion can be substantially rectangular in shape with a length and a height and the tapered end portion can be substantially triangular in shape. Substantially rectangular means any shape resembling a four-sided polygon, which may have rounded corners. Substantially triangular means any shape resembling a three-sided polygon, which may have rounded corners. The tapered end portion can also be formed in a shape selected from the group consisting of a right triangle, an equilateral triangle, an acute triangle, an obtuse triangle, a scalene triangle, and an isosceles triangle. Furthermore, one or more edges of the tapered end portion can be formed into a saw-tooth pattern.

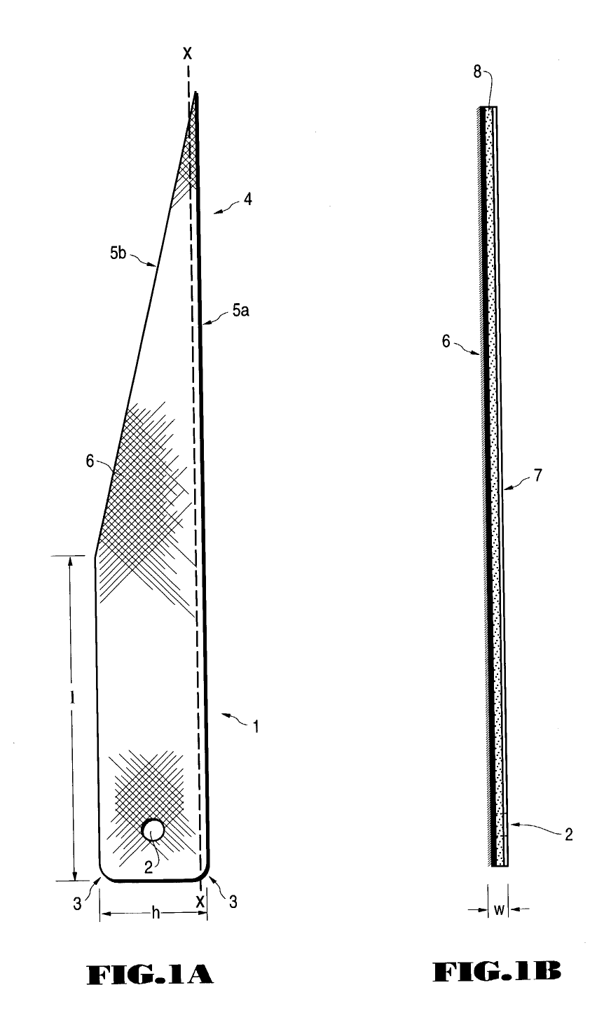

In one embodiment, the apparatus is a laminate that is about 22.5 cm. in length, as illustrated in FIG. 1A. The laminate has a body portion 1 that is substantially rectangular with a height h of about 3 cm. and a length l of about 9.5 cm. and a tapered end portion 4 in the shape of a right triangle extending from one of the short ends of the body portion 1. The tapered end portion is about 3 cm. at the base (corresponding to the height of the body portion) with a 13.5 cm. right side edge 5A and about a 14 cm. hypotenuse edge 5B. The apex of the triangular tapered end portion can be pointed for enhanced functionality 4. The apparatus can also have a hole 2 placed in the body portion, e.g., near the short end of the rectangular body portion, to provide a place for attachment, e.g., to a ring or chain. Furthermore, the exposed corners of the rectangular body portion 3 can be rounded for aesthetic purposes 3.

As illustrated by FIG. 1B, one surface of the invention is a woven layer 6, e.g., a medium-short terry cloth made from double or single knit microfiber, which was obtained as microfiber MFT 11.3 from Leading Edge Products located in San Diego, Calif. The woven layer is laminated to a planar backing layer 7 made of a resilient material, e.g., a 0.04 millimeter thick ABS plastic, that is smooth on the exposed surface. The woven layer and the backing layer can be attached by using a suitable adhesive 8, which is preferably resistant to solvents that may be used to clean the mechanical component. The attachment surface of the backing layer can be rough or uneven, e.g. made to form a pebbled surface, to enhance the bond with the adhesive 8. The resulting laminate is capable of sliding in between the gears on most multi-gear bicycles. The smooth plastic surface facilitates sliding the apparatus between the gears while the opposing terry cloth surface cleans foreign matter from between the gears and on the gear surfaces themselves. The specific shape of the apparatus may be adjusted to reach newly designed components. For example, the tapered end portion may include a shape that conforms to the shape of the component, e.g., in the form of a hook. Further, the precise nature of the woven layer 6 and thickness of the backing layer 7 may be adjusted to accommodate more precise tolerances of gear spacing as the industry seeks to pack more gears into a confined space.

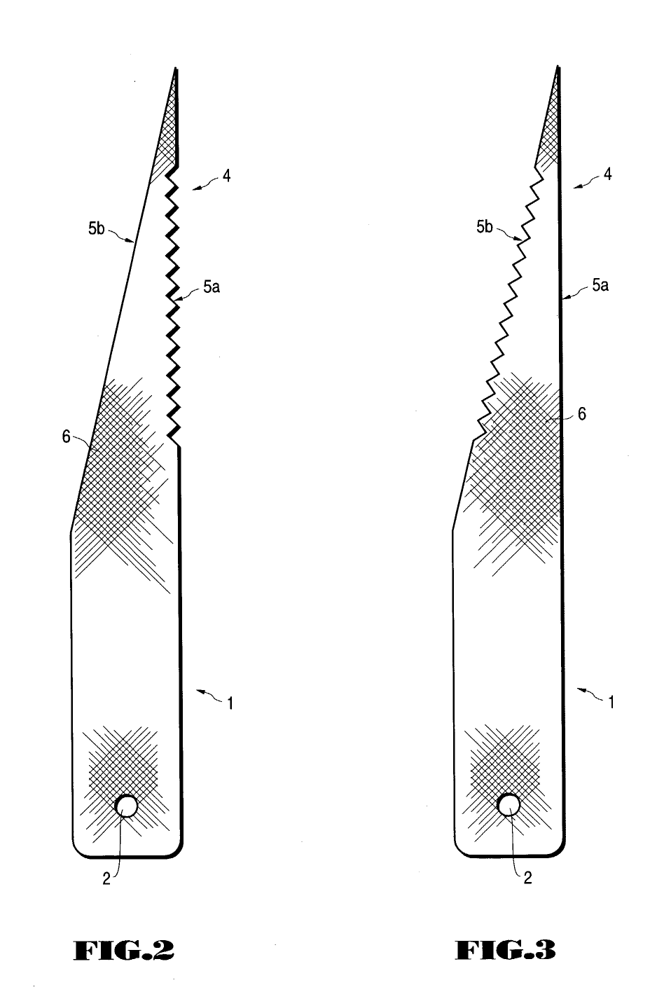

One or more the edges 5A, 5B of the tapered end portion can be formed into a saw-toothed pattern to provided an enhanced cleaning capabilities. Illustrated in FIG. 2 is one embodiment, wherein the right side edge 5A of the triangular tapered end portion is formed into a saw-toothed pattern. Another embodiment is illustrated in FIG. 2, wherein the hypotenuse side edge 5B of the triangular tapered end portion is formed into a saw-toothed pattern.

The present invention is also directed to a method of using the above-described apparatus. The method includes placing the apparatus in the void space of a mechanical component and contacting the woven layer with a surface of the mechanical component. The method can further include the step of applying a cleaning solution, e.g., fluids designed to dissolve gear lubrication and loosen debris, to the woven layer to enhance the cleaning process. The woven layer 6 can be used to carry the cleaning fluid or lubrication into the void spaces of a mechanical component. After use, the invention may be cleaned in a washing machine or by hand washing. Alternatively, the invention can be used until it is worn out, and then discarded.

What is claimed is:

1. An apparatus for cleaning a mechanical component with a void space, the apparatus comprising:
a planar backing layer made of a resilient material; and
a woven layer attached to the backing layer to form a laminate;
wherein the laminate is substantially flat and shaped to have an elongated body portion and at least one tapered end portion.

2. The apparatus according to claim 1, wherein the body portion is formed into a shape selected from the group consisting of a polygon, an ellipse, and a circle; and wherein the tapered end portion is formed into a shape selected from the group consisting of a hook or polygon.

3. The apparatus according to claim 1, wherein the elongated body portion has a substantially rectangular shape having a length and a height and the tapered end portion has a substantially triangular shape.

4. The apparatus according to claim 3, wherein the tapered end portion is formed in a shape selected from the group consisting of a right triangle, an equilateral triangle, an acute triangle, an obtuse triangle, a scalene triangle, and an isosceles triangle.

5. The apparatus according to claim 4, wherein the tapered end portion is formed in the shape of a right triangle.

6. The apparatus according to claim 3, wherein at least one edge of the tapered end portion is formed in a saw-tooth pattern.

7. The apparatus according to claim 1, wherein the backing layer is made of a flexible material and wherein the woven layer is made of a fabric.

8. The apparatus according to claim 7, wherein the backing layer is made of a plastic, and wherein the woven layer is made of a material selected from the group consisting of unsplit microfiber, split microfiber, cloth, and combinations thereof.

9. A method of cleaning a mechanical component with a void space, the method comprising,
placing a cleaning apparatus in the void space of a mechanical component, the apparatus comprising,
a planar backing layer made of a resilient material, and
a woven layer attached to the backing layer to form a laminate,
wherein the laminate is substantially flat and shaped to have an elongated body portion and at least one tapered end portion; and
contacting the woven layer with a surface of the mechanical component.

10. The method according to claim 9, further comprising the step of applying a cleaning solution to the woven layer before the placing step.

11. The method according to claim 9, wherein the body portion of the cleaning apparatus is formed into a shape selected from the group consisting of a polygon, an ellipse, and a circle; and wherein the tapered end portion of the cleaning apparatus is formed into a shape selected from the group consisting of a hook or polygon.

12. The method according to claim 9, wherein the elongated body portion has a substantially rectangular shape having a length and a height and wherein the tapered end portion has a substantially triangular shape.

13. The method according to claim 12, wherein the tapered end portion is formed in a shape selected from the group consisting of a right triangle, an equilateral triangle, an acute triangle, an obtuse triangle, a scalene triangle, and an isosceles triangle.

14. The method according to claim 13, wherein the tapered end portion is formed in the shape of a right triangle.

15. The method according to claim 12, wherein at least one edge of the tapered end portion is formed in a saw-tooth pattern.

16. The method according to claim 9, wherein the backing layer is made of a flexible material and wherein the woven layer is made of a fabric.

17. The method according to claim 16, wherein the backing layer is made of a plastic, and wherein the woven layer is made of a material selected from the group consisting of unsplit microfiber, split microfiber, cloth, and combinations thereof.
